(19) United States
(12) Patent Application Publication
(10) Pub. No.: US 2013/0343090 A1
(43) Pub. Date: Dec. 26, 2013

(54) ACTIVE BLEEDER, ACTIVE BLEEDING METHOD, AND POWER SUPPLY DEVICE WHERE THE ACTIVE BLEEDER IS APPLIED

(71) Applicant: Fairchild Korea Semiconductor Ltd., Bucheon (KR)

(72) Inventors: Hyun-Chul EOM, Seoul (KR); In-Ki PARK, Anyang-si (KR)

(21) Appl. No.: 13/920,272

(22) Filed: Jun. 18, 2013

Related U.S. Application Data
(60) Provisional application No. 61/662,493, filed on Jun. 21, 2012.

(30) Foreign Application Priority Data
May 23, 2013 (KR) 10-2013-0058582

(51) Int. Cl. H02M 3/335

(52) U.S. Cl. CPC H02M 3/33507
USPC 363/16

(57) ABSTRACT

An active bleeder according to an exemplary embodiment of the present invention includes a bleed switch coupled to the input voltage and an active bleeding controller generating a bleed reference voltage according to a result of counting a period during which the input voltage is generated and switching the bleed switch according to a result of comparison between the bleed reference voltage and a bleed sense voltage corresponding to a current flowing to the bleed switch.

### CROSS-REFERENCE TO RELATED APPLICATION

This application claims priority to and the benefit of U.S. Patent Application No. 61/662, 493, filed with the USPTO on Jun. 21, 2012, and priority to and the benefit of Korean Patent Application No. 10-2013-0058582, filed with the Korean Intellectual Property Office on May 23, 2013, the entire contents of which are incorporated herein by reference.

### BACKGROUND OF THE INVENTION

(a) Field of the Invention

The present invention relates to an active bleeder, an active bleeding method, and a power supply to which the active bleeder is applied.

(b) Description of the Related Art

A triac dimmer passes each cycle of a sine wave of an AC input by a dimming angle. In order to maintain the triac dimmer in a turn-on state, more than a predetermined holding current should flow through the dimmer.

When a current flowing through the dimmer is lower than a sustain current, the dimmer is turned off. Hereinafter, the current flowing through the dimmer is referred to as an input current. When the input current iteratively higher than or lower than the sustain current, the dimmer is iteratively turned on/off, thereby causing a flicker. When the dimming angle is small, a period during which an input voltage supplied to the power supply is short. Then, the current supplied to the power supply lacks so that the flicker may occur.

In order to prevent occurrence of the flicker, a bleeder is used to maintain the input current to be higher than the sustain current. A typical bleeder senses an input voltage passed through a rectification circuit, and determines that the input current is lower than the sustain current when the input voltage is lower than a predetermined reference value. When it is determined that the input current is lower than the sustain current, the bleeder generates a current to compensate a difference between the two currents.

The current generated by the bleeder is not a current that varies to compensate the difference between the two currents but a constant current. Therefore, power is unnecessarily consumed as much as a current remaining after compensation of a difference between the two currents. Due to the increase of power consumption, an operation temperature of the bleeder is also increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an active bleeding method for reducing unnecessary power consumption caused by a current flowing to a bleeder.

The active bleeding method according to an exemplary embodiment of the present invention controls a bleeding current among an input current. The active bleeding method includes counting a period during which the input voltage is generated using an auxiliary voltage which is a both-end voltage of an auxiliary coil and switching the bleed switch according to a result of comparison between a bleed reference voltage that depends on the count result and a bleed sense voltage that corresponds to a current flowing to the bleed switch.

An active bleeder coupled to an input voltage of a power supply according to an exemplary embodiment of the present invention includes a bleed switch coupled to the input voltage and an active bleeding controller generating a bleed reference voltage according to a result of counting a period during which the input voltage is generated and switching the bleed switch according to a result of comparison between the bleed reference voltage and a bleed sense voltage than corresponds to a current flowing to the bleed switch.

The active bleeder includes a first resistor coupled to the input voltage and a first electrode of the bleed switch, a second resistor coupled between a second electrode of the bleed switch and a ground, and a third resistor of which a first terminal is coupled to the ground. A voltage of a second terminal of the third resistor is the bleed sense voltage.

The active bleeding controller counts the period during which the input voltage is generated using a sense voltage that corresponds to an auxiliary voltage of lateral ends of an auxiliary coils that is coupled to a secondary coil, coupled to an output voltage of the power supply, with a predetermined turn ratio

The active bleeding controller generates an input sense voltage by using a source current generated to maintain the sense voltage with a predetermined clamping voltage, counts a result of comparison between a sampling voltage generated by sampling the input sense voltage and a predetermined first reference voltage, and determines the bleed reference voltage that corresponds to the comparison result.

The active bleeding controller may include a clamping circuit that supplies the source current to a node where a first sense resistor and a second sense resistor that are coupled in series between lateral ends of the auxiliary coil are coupled when the sense voltage is lower than the predetermined clamping voltage.

The clamping circuit includes a BJT including a first electrode coupled to the node, a diode coupled between a control electrode of the BJT and the ground, and a fourth resistor coupled between the control electrode of the BJT and a predetermined voltage. When the BJT is turned on by the bleed sense voltage, the source current flows through the BJT.

The active bleeding controller generates the input sense voltage by flowing a mirror current generated by mirroring the source current to a sense resistor.

The active bleeding controller may include a sample/hold unit generating the sampling voltage by sampling and holding the input sense voltage with a predetermined sampling cycle.

The active bleeding controller may include a comparator comparing the input sense voltage and the first reference voltage and a counter counting a period during which an output of the comparator has a first level.

The active bleeding controller may include a DAC that generates the bleed reference voltage by converting a digital count signal that corresponds to the count result into an analog signal, and the DAC generates a bleed reference voltage having a level that depends on the count signal when the count signal is higher than a predetermined reference value.

The DAC generates a bleed reference voltage having a minimum-level when the count signal is lower than the predetermined reference value.

The active bleeding controller may include a comparison unit that generates a bleeding control signal according to a result of comparison between the bleed reference voltage and a current sense voltage that corresponds to the bleed sense voltage. The bleed switch performs a switching operation according to the bleeding control signal.

The comparison unit may include a fifth resistor including a first terminal coupled with a predetermined-level voltage, a sixth resistor including a first terminal to which the bleed sense voltage is applied and a second terminal coupled to a second terminal of the fifth resistor; and a comparator generating the bleeding control signal according to a result of comparison between the current sense voltage which is a voltage of a node where the fifth resistor and the sixth resistor are coupled and the bleed reference voltage.

The current sense voltage is input to a non-inverse terminal of the comparator, the bleed reference voltage is input to an inverse terminal of the comparator, and the predetermined-level voltage coupled to the first terminals of the fifth and sixth resistors is set to a value that prevents the current sense voltage from being a negative voltage.

An active bleeding method according to an exemplary embodiment of the present invention controls a bleed switch coupled to an input voltage that is rectified from an AC input. The active bleeding method includes: counting a period during which the input voltage is generated using an auxiliary voltage which is a both-end voltage of an auxiliary coil; and switching the bleed switch according to a result of comparison between a bleed reference voltage that depends on the count result and a bleed sense voltage that corresponds to a current flowing to the bleed switch. The auxiliary coil is coupled with a second coil, which is coupled to an output voltage of a power supply coupled to the input voltage, with a predetermined turn ratio.

The counting includes supplying a source current to maintain a sense voltage that corresponds to the auxiliary voltage of the lateral ends of the auxiliary coil with a predetermined clamping voltage.

The active bleeding method further includes converting the count result into the bleed reference voltage when the count result is greater than a predetermined reference value.

The active bleeding method further includes outputting a minimum-level bleeding reference voltage when the count result is smaller than a predetermined reference value.

A power supply according to an exemplary embodiment of the present invention includes: a first coil including a first terminal coupled to an input voltage; a power switch coupled to a second terminal of the first coil; a second coil coupled to an output voltage; an auxiliary coil coupled with the second coil with a predetermined turn ratio; and an active bleeder counting a period during which the input voltage is generated using an auxiliary voltage generated in the auxiliary coil and being enabled or disabled according to the count result.

The active bleeder includes a bleeder switch coupled to the input voltage and an active bleeding controller generating a bleed reference voltage according to the count result and switching the bleeder switch according to a result of comparison between the bleed reference voltage and a bleed sense voltage that corresponds to a current flowing to the bleed switch.

The active bleeding controller generates an input sense voltage using a source current that is generated to maintain a sense voltage corresponding to the auxiliary voltage with a predetermined clamping voltage and counts a result of comparison between a sampling voltage generated by sampling the input sense voltage and a predetermined first reference voltage, and a result of counting the comparison result of the sampling voltage and the first reference voltage corresponds to a count result of a period during which the input voltage is generated.

The active bleeding controller generates the sampling voltage by sampling and holding the input sense voltage with a predetermined sampling cycle.

According to the exemplary embodiments of the present invention, the active bleeding method can reduce unnecessary power consumption due to a current flowing to a bleeder.

### BRIEF DESCRIPTION OF THE DRAWINGS

FIG. 1 shows a power supply to which an active bleeder and an active bleeding controller are applied according to an exemplary embodiment of the present invention.

FIG. 2 shows the active bleeding controller according to the exemplary embodiment of the present invention.

FIG. 3 shows the active bleeding controller according to the exemplary embodiment of the present invention in detail.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

When a power supply is coupled to a dimmer, an input voltage of the power supply is generated by rectifying an AC input passed through a dimmer. When the power supply is not coupled to the dimmer, the input voltage of the power supply is generated by rectifying an AC input.

An active bleeder control means (hereinafter, an active bleeding controller) according to an exemplary embodiment of the present invention blocks a bleeder current by disabling an active bleeder when no dimmer is provided or a dimming angle has the maximum angle. Otherwise, the active bleeding controller enables the active bleeder. Then, the input current is controlled to be above a sustain current.

As previously stated, a bleeder current is generated to solve a problem caused by a short period for generating an input voltage, and when the input voltage become sufficient when no dimmer is provided or the dimming angle has the maximum angle, and therefore no bleeder current is needed.

The active bleeding controller senses an input voltage, and when the input voltage is sufficient, the active bleeding controller blocks a bleeder current by setting a sustain current to be low.

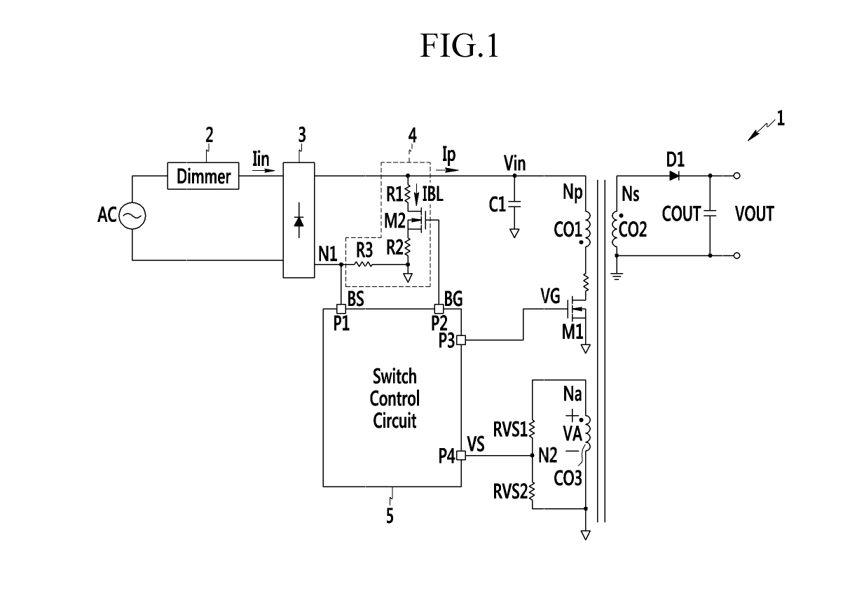

Hereinafter, an active bleeding method according to an exemplary embodiment of the present invention will be described with reference to FIG. 1 to FIG. 3.

FIG. 1 shows a power supply to which an active bleeder and an active bleeding controller according to the exemplary embodiment of the present invention is applied.

A power supply 1 supplies power to a load using an AC input AC. The power supply 1 according to the exemplary embodiment of the present invention includes a switch mode power supply (SMPS). In FIG. 1, an input capacitor C1 to which an input voltage Vin is input, a first coil CO1, a second coil CO2, a power switch M1, a rectification diode D1, and an output capacitor COUT are parts of the SMPS.

Further, although it is illustrated that the power supply 1 includes a dimmer 2 in FIG. 1, but the present invention is not limited thereto. The power supply 1 may not include the dimmer 2.

The AC input AC passed through the dimmer 2 is full-wave rectified by the rectification circuit 3 and then generated as the input voltage Vin. The AC input AC passed through the dimmer 2 is determined according to a dimming angle of the dimmer 2. For example, the AC input AC passing through the dimmer 2 is increased as the dimming angle is large and the AC input AC passing the dimmer 2 becomes the maximum when the dimming angle is increased to the maximum.

An input current Iin flows through the rectification circuit 3, and corresponds to the sum of a bleed current IBL flowing to the active bleeder 4 and a current Ip supplied to the SMPS. The current Ip supplied to the SMPS is decreased as the input voltage Vin is decreased. In such a condition, the bleeder current IBL flowing to the active bleeder 4 is increased to maintain the input current Iin to be at least the sustain current.

As the input voltage Vin is increased, the current Ip supplied to the SMPS is increased and the input current Iin may be higher than the sustain current. In such a condition, the active bleeder 4 is disabled and thus the bleeder current IBL does not flow any longer. As described, an operation condition of the active bleeder 4 is changed depending on the sustain current.

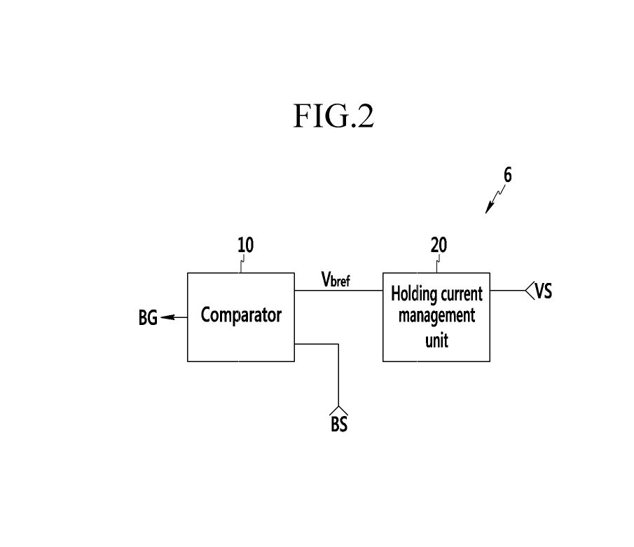

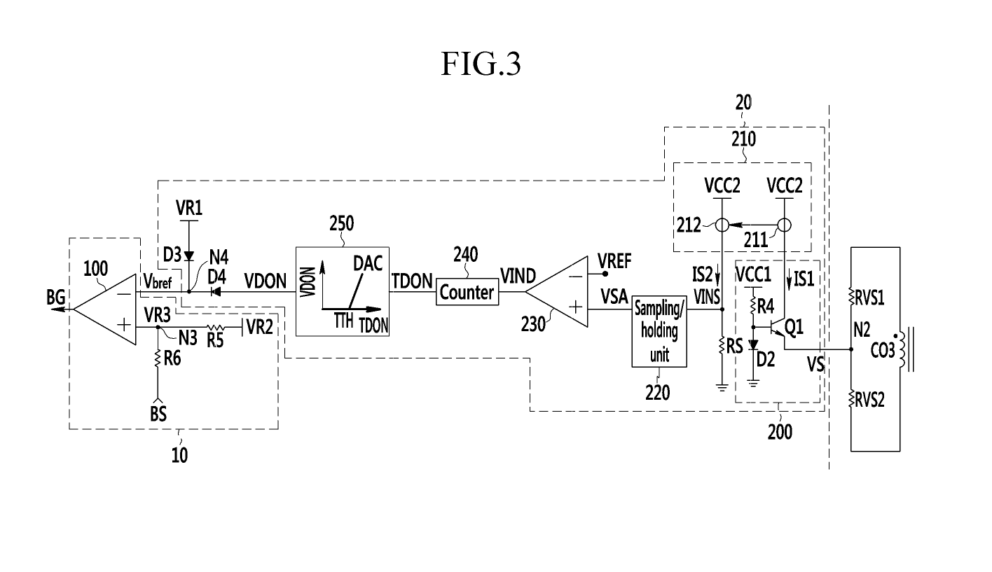

In the exemplary embodiment of the present invention, when the dimming angle of the dimmer 2 is sufficient enough or no dimmer is provided, a bleed reference voltage corresponding to the sustain current is varied to control the operation of the active bleeder 4. This will be described later with reference to FIG. 2 and FIG. 3.

A first output terminal of the rectification circuit 3 is coupled to the input capacitor C1 and the first coil CO1, and a second output terminal of the rectification circuit 3 is coupled to a ground through a resistor R3. While the active bleeder 4 is in the enable state, the bleed current IBL flows to the rectification circuit 3 and a voltage of a first node N1 is lower than the ground voltage. Hereinafter, the voltage of the first node N1 is referred to as a bleeding sense voltage BS. Thus, the bleeding sense voltage BS input through a sense pin P1 is a negative voltage.

The active bleeder 4 is disabled when the dimming angle is greater than a predetermined reference angle (or, when no dimmer is provided). In further detail, a bleed switch M2 of the active bleeder 4 is turned off. The active bleeder 4 includes three resistors R1, R2, and R3 and a bleed switch M2.

A first terminal of the resistor R1 is coupled to the input voltage Vin, and a drain electrode of the bleed switch M2 is coupled to a second terminal of the resistor R1. The resistor R2 is coupled between a source electrode of the bleed switch M2 and the ground. The resistor R3 includes a first terminal coupled to the ground and a second terminal coupled to the first node N1.

A gate electrode of the bleed switch M2 is coupled to a control pin P2, and a bleeding control signal BG is transmitted to the gate electrode. While the active bleeder 4 is in the enable state, the bleed switch M2 is turned on by a high-level bleeding control signal BG. While the active bleeder 4 is in the disable state, the bleed switch M2 is turned off by a low-level bleeding control signal BG.

The input capacitor C1 makes the input voltage Vin smooth.

The first terminal of the first coil CO1, disposed in the primary side of the power supply 1 is coupled to the input capacitor C1, and the input voltage Vin is supplied thereto. The second terminal of the first coil CO1 is coupled to the power switch M1. A turn ratio (Na/Np) between turns Na of an auxiliary coil CO3 and turns Np of the first coil CO1 is called wn1. The auxiliary coil CO3 and the first coil CO1 are coupled with the turn ratio wn1.

The second coil CO2 disposed in the secondary side of the power supply 1 is coupled to the output capacitor COUT through a rectification diode D1, and a turn ratio (Na/Ns) between turns Na of the auxiliary coil CO3 and turns Ns of the second coil CO2 is called wn2. The auxiliary coil CO3 and the second coil CO2 are coupled with the turn ratio wn2.

The rectification diode D1 includes an anode coupled to a first terminal of the second coil CO2 and a cathode coupled to a second terminal of the output capacitor COUT. The output capacitor COUT is charged by a current passed through the rectification diode D1 and maintains an output voltage VOUT.

A voltage of a second node N2 to which a first sense resistor RVS1 and a second sense voltage RVS2 that are coupled in series between lateral ends of the auxiliary coil CO3 are coupled will be referred to as a sense voltage VS. The second node N2 is coupled to a sense pin P4.

A switch control circuit 5 includes a bleed sense pinP1, a bleed sense pinP2, a gate pin P3, and a sense pin P4. The gate pin P3 is coupled to the gate electrode of the power switch M1.

Hereinafter, a bleeding controller 6 will be described in further detail with reference to FIG. 2. In the exemplary embodiment of the present invention, the bleeding controller 6 is included in the switch control circuit 5, but the present invention is not limited thereto.

FIG. 2 shows the bleeding controller according to the exemplary embodiment of the present invention.

As shown in FIG. 2, the bleeding controller 6 includes a comparator 10 and a sustain current management unit 20.

The sustain current management unit 20 counts a period during which the input voltage Vin is generated using the sense voltage VS, and transmits a bleed reference voltage Vbref that depends on the count result to the comparator 10. In this case, the bleed reference voltage Vbref is a voltage corresponding to the sustain current, and the sustain current management unit 20 can vary the sustain current by varying the bleed reference voltage Vbref.

The comparator 10 compares the bleed reference voltage Vbref with the bleeding sense voltage BS, and generates a bleeding control signal BG according to the comparison result.

For example, since the bleeding sense voltage BS is a negative voltage, the bleed reference voltage Vbref may be set to a negative voltage. In the negative voltage, a relatively high voltage has a low absolute value and a relatively low voltage has a high absolute value.

As the bleed current IBL is increased, the bleeding sense voltage BS is decreased (i.e., the absolute value is increased), and as the bleed current IBL is decreased, the bleeding sense voltage BS is increased (i.e., the absolute value is decreased).

The bleed current comparator 10 generates a bleeding control signal BG that turns off the bleed switch M2 when the bleeding sense voltage BS, which is a negative voltage, is higher than the bleed reference voltage Vbref, and generates a bleeding control signal BG that turns on the bleed switch M2 when the bleeding sense voltage BS is lower than the bleed reference voltage Vbref.

As shown in FIG. 1, the bleed switch M2 is realized as an n-channel type MOSFET, and therefore, the bleed switch M2 is turned on by a high-level bleeding control signal BG and turned off by a low-level bleeding control signal BG.

As described, the bleed current IBL is not generated when a current higher than the sustain current flows to the SMPS, and therefore power consumption can be reduced.

FIG. 3 shows the bleeding controller according to the exemplary embodiment of the present invention in detail.

As shown in FIG. 3, the sustain current management unit 20 includes a clamping circuit 200, a current mirroring circuit 210, a sample/hold unit 220, a comparator 230, a counter 240, a digital-analog converter (hereinafter, referred to as DAC) 250, and a sense resistor RS.

The clamping circuit 200 clamps the sense voltage VS generated during the turn-on period of the power switch M1 to a predetermined voltage (e.g., 0V). During the clamping operation, a source current IS1 is supplied to the auxiliary coil CO3. The clamping circuit 200 includes a resistor R4, a diode D2, and a BJT Q1.

In further detail, during the turn-on period of the power switch M1, the voltage of the first coil CO1 becomes the input voltage Vin, and a negative voltage (−wn1*Vin) obtained by multiplying the turn ratio wn1 to the input voltage Vin is generated as a voltage VA (hereinafter, referred to as an auxiliary voltage) of the auxiliary coil CO3.

During the turn-on period of the power switch M1, the auxiliary voltage VA is a negative voltage and the source current IS1 flows to the auxiliary coil CO3 through the clamping circuit 200. In this case, the second node N2 coupled to the clamping circuit 200 is equivalent to a cathode potential of the diode D2. Accordingly, the sense voltage VS is clamped to zero voltage.

Among the AC input AC, a portion (i.e. a portion not included in the dimming angle) sharpened by the dimmer 2 has an input voltage Vin of zero voltage. Since the auxiliary voltage VA of the portion is still zero voltage even through the power switch M1 is turned on, a current flowing to the auxiliary coil CO3 from the clamping circuit 200 is not generated.

When the power switch M1 is turned off, a voltage of the second coil CO2 is an output voltage VOUT. The auxiliary voltage VA becomes a positive voltage obtained by multiplying the turn ratio wn2 to the voltage of the second coil CO2. Then, a current flowing to the auxiliary coil CO3 from the second node N2 is not generated. That is, the source current IS1 does not flow.

As described, when the auxiliary voltage VA is zero voltage or a positive voltage, the clamping circuit 200 is not operated and the source current IS1 does not flow. A period during which the source current IS1 is generated according to the exemplary embodiment of the present invention is a period during which the input voltage Vin exists and the power switch M1 is turned on. As describe, the source current IS1 generated during clamping operation of the clamping circuit 200 depends on the auxiliary voltage VA and the auxiliary voltage VA during the turn-on period of the power switch M1 depends on the input voltage Vin, and therefore the source current IS1 depends on the input voltage Vin.

The resistor R4 includes a first terminal to which a voltage VCC1 is input and a second terminal coupled to a base of the BJT Q1. An anode of the diode D2 is coupled to the base of the BJT Q1 and a cathode of the diode D2 is coupled to the ground. A connector of the BJT Q1 is coupled to the current mirroring circuit 210 and an emitter of the BJT Q1 is coupled to the second node N2.

A voltage of the base of the BJT Q1 is maintained to be a threshold voltage (e.g., 0.7V) of the diode D2, and the threshold voltage of the BJT Q1 is set to be the same as the voltage of the diode D2. During the turn-on period of the power switch M1, the source current IS1 flowing to the BJT Q1 is generated, and in this case, the emitter voltage of the BJT Q1 is a voltage obtained by subtracting the threshold voltage from the base voltage of the BJT Q1, and therefore the sense voltage VS is maintained to be zero voltage.

The current mirroring circuit 210 generates a mirror current IS2 by mirroring the source current IS1 flowing to the clamping circuit 200. The current mirroring circuit 210 includes a first current source 211 and a second current source 212.

The first current source 211 is coupled between the voltage VCC2 and the BJT Q1, and supplies the source current IS1 to the clamping circuit 200 using a voltage source of the voltage VCC2. The second current source 212 is coupled to a voltage VCC2, and generates a mirror current IS2 by mirroring the source current IS1 using the voltage VCC2. In the exemplary embodiment of the present invention, the source current IS1 is set to be equivalent to the mirror current IS2.

The mirror current IS2 flows to the sense resistor RS and thus an input sense voltage VINS is generated.

The sample/hold unit 220 generates a sampling voltage VSA by sampling the input sense voltage VINS for every switching cycle of the power switch M1 and holds the sampling voltage VSA. For example, the sample/hold unit 220 generates the sampling voltage VSA during the turn-on period of the power switch M1 and holds the sampling voltage VSA before the next turn-on period of the power switch M1.

The comparator 230 generates an input detection voltage VIND according to a result of comparison between the sampling voltage VSA and a reference voltage VREF. The reference voltage VREF is a voltage set to sense an existing period of the input voltage Vin and may be a low voltage close to zero voltage.

For example, the comparator 230 includes a non-inverse terminal (+) to which the sampling voltage VSA is input and an inverse terminal (−) to which the reference voltage VREF is input, and generates a high-level input detection signal VIND when an input of the non-inverse terminal (+) is higher than an input of the inverse terminal (−) and generates a low-level input detection signal VIND when the input of the non-inverse terminal (+) is lower than the input of the inverse terminal (−). The input detection signal VIND maintains high level while the input voltage Vin exists.

The counter 240 counts a high-level period of the input detection signal VIND. In addition, an output of the counter 240 is the count result, that is, a count signal TDON. The count signal TDON is a digital signal indicating a period during which the input voltage Vin is generated.

The DAC 250 generates a bleed reference voltage Vbref according to the count signal TDON. When the count signal TDON is lower than a predetermined reference value, the DAC 250 converts the count signal TDON into a bleed reference voltage Vbref having a first level, and when the count signal TDON is higher than the predetermined reference value, the DAC 250 converts a bleed reference voltage Vbref of which a level depends on the count signal TDON.

As shown in FIG. 3, when the count signal TDON is lower than a predetermined reference value TTH, the DAC 250 outputs 0.5V without regard to the count signal TDON. When the count signal TDON is higher than the reference value TTH, the DAC 250 generates a bleed reference voltage Vbref by converting the count signal TDON

In further detail, when the count signal TDON is higher than the reference value TTH, the DAC 250 converts the count signal TDON into a bleed reference voltage Vbref according to a predetermined inclination. The bleed reference voltage Vbref is input to an inverse terminal (−) of a comparator 100.

The comparator 100 generates a high-level bleeding control signal BG that turns on the bleed switch M2 when a current sense voltage VR3, which is a voltage of a node N3, is higher than the bleed reference voltage Vbref. The comparator 100 generates a low-level bleeding control signal BG that turns off the bleed switch M2 when the current sense voltage VR3 is lower than the bleed reference voltage Vbref.

The comparison unit 10 includes two resistors R5 and R6 and the comparator 100. The comparator 100 generates a high-level bleeding control signal BG when an input of the non-inverse terminal (+) is higher than an input of the inverse terminal (−), and generates a low-level bleeding control signal BG when the input of the non-inverse terminal (+) is lower than the input of the inverse terminal (−).

The node N3 where the resistor R5 and the resistor R6 are coupled is coupled to a bleed sense pinP1 through the resistor R6. Thus, a voltage (hereinafter, a current sense voltage) VR3 of the node N3 is a voltage obtained by adding a voltage divided from a voltage difference between the voltage VR2 and the bleed sense voltage BS by the resistor R5 and the resistor R6 to the bleed sense voltage BS. This will be shown as the following Equation 1.

$$\begin{matrix}VR 3 = ( VR 2 - BS ) * ( R 6 \text{/} ( R 5 + R 6 ) ) + BS \\ = ( VR 2 * R 6 + BS * R 5 ) \text{/} ( R 5 + R 6 )\end{matrix} \qquad [ Equation 1 ]$$

By using the two resistors R5 and R6 and the voltage VR2, the input of the non-inverse terminal (+) of the comparator 100 can prevented from being set to a negative voltage. It may be difficult to circuitally realize a comparator that compares negative voltages circuit. For this reason, in the exemplary embodiment of the present invention, the resistors R5 and R6 and the voltage VR2 are used to generate a positive voltage according to the bleed sense voltage BS.

For example, the voltage VR2 is 1V and a ratio between the resistor R5 and the resistor R6 is 1:2. In this case, when the bleeding sense voltage BS is −0.5V, a voltage (i.e., 1V) divided from a voltage difference (i.e., 1.5V) between the voltage VR2 and the bleed sense voltage BS according to the ratio (i.e., 1:2) is added to the bleed sense voltage BS such that the current sense voltage VR3 is acquired. That is, the current sense voltage VR3 is 0.5V.

The comparator 100 turns on the bleed switch when the current sense voltage VR3 is higher than the bleed reference voltage Vbref. Then, the bleed current IBL flows so that the bleed sense voltage BS is decreased and thus the current sense voltage VR3 is decreased. The comparator 100 turns off the bleed switch when the current sense voltage VR3 is lower than the bleed reference voltage Vbref. Then, the bleed current IBL is blocked so that the bleed sense voltage BS is increased and thus the current sense voltage VR3 is increased.

That is, the comparator 100 controls the bleed switch M2 to maintain the current sense voltage VR3 with the bleed reference voltage Vbref. For example, when the bleed reference voltage Vbref is 0.5V, the comparator 100 controls the switching operation of the bleed switch M2 to maintain the current sense voltage VR3 to be 0.5V.

For example, when the bleeding sense voltage BS becomes −1V, the current sense voltage VR3 becomes ⅓V (approximately, 0.33V). Then, the comparator 100 generates a low-level bleeding control signal BG and the bleed switch M2 is turned off. That is, when an input current exceeds the sustain current due to the bleed current IBL, the comparator 100 turns off the bleed switch M2.

When bleed sense voltage BS becomes −0.1V, the current sense voltage VR3 approximately becomes 0.63V. Then, the comparator 100 generates a high-level bleeding control signal BG and the bleed switch M2 is turned on. That is, the bleed switch M2 is turned on to maintain the input current Iin with at least the sustain current by supplying the bleed current IBL.

In the exemplary embodiment of the present invention, when the count signal TDON that counts the period during which the input voltage Vin is generated is lower than the reference value TTH, the bleed reference voltage Vbref is maintained with the minimum value (e.g., 0.5V).

However, as previously stated, there is no need of reducing power consumption by minimizing a bleeding current when no dimmer is provided or the dimming angle is sufficiently large. When no dimmer is provided or the dimming angle is sufficiently large, the count signal TDON has a high value.

Since the DAC 250 converts the count signal TDON into a bleed reference voltage Vbref according to the predetermined inclination, the bleed reference voltage Vbref is increased as the count signal TDON is increased. That is, as the generation period of the input voltage is increased, the bleed reference voltage Vbref is increased to minimize a bleeding current.

For example, when the bleed reference voltage Vbref is 0.7V and the bleed sense voltage BS is −0.1V, the bleed switch M2 is turned off because the current sense voltage VR3 is lower than the bleed reference voltage Vbref.

As described, when a bleed reference voltage Vbref that corresponds to a sustain current is controlled according to a generation period of an input voltage, a turn-on period of the bleed switch M2 is decreased, thereby reducing power consumption of the bleed switch M2.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| power supply 1 | dimmer 2 |
| rectification circuit 3 | active bleeder 4 |
| switch control circuit 5 | bleeding controller 6 |
| input capacitor C1 | output capacitor COUT |
| power switch M1 | bleed switch M2 |
| first coil CO1 | second coil CO2 |
| auxiliary coil CO3 | BJT Q1 |
| rectification diode D1 | resistor (R1-R6) |
| diode D2 | bleed sense pinP1 |
| Control pin P2 | gate pin P3 |
| sense pin P4 | comparator 10 |
| sustain current management unit 20 | clamping circuit 200 |
| current mirroring circuit210 | sample/hold unit 220 |
| comparator 230, 100 | counter 240 |
| DAC 250 | sense resistor RS |
| first current source 211 | second current source 212 |

What is claimed is:

1. An active bleeder coupled to an input voltage of a power supply, the active bleeder comprising:
a bleed switch coupled to the input voltage; and
an active bleeding controller configured to generate a bleed reference voltage based on a result of a counted period during which the input voltage is generated and further configured to switch the bleed switch based on a comparison between the bleed reference voltage and a bleed sense voltage corresponding to a current flowing to the bleed switch.

2. The active bleeder of claim 1, further comprising:
a first resistor coupled to the input voltage and a first electrode of the bleed switch;
a second resistor coupled between a second electrode of the bleed switch and a ground; and
a third resistor having a first terminal and a second terminal, the first terminal being coupled to the ground,
wherein a voltage of the second terminal is the bleed sense voltage.

3. The active bleeder of claim 1, wherein the active bleeding controller is configured to count the period during which the input voltage is generated using a sense voltage corresponding to an auxiliary voltage of lateral ends of an auxiliary coil coupled to a secondary coil with a predetermined turn ratio, the secondary coil being coupled to an output voltage of the power supply.

4. The active bleeder of claim 3, wherein the active bleeding controller is configured to generate an input sense voltage by using a source current generated to maintain the sense voltage with a predetermined clamping voltage, the active bleeding controller being further configured to count a result of a comparison between a sampling voltage and a predetermined first reference voltage, the sampling voltage being generated based on a sampling of the input sense voltage, and the active bleeding controller being further configured to determine the bleed reference voltage corresponding to the comparison result.

5. The active bleeder of claim 4, wherein the active bleeding controller comprises a clamping circuit configured to supply the source current to a node when the sense voltage is lower than the predetermined clamping voltage, wherein a first sense resistor and a second sense resistor are coupled to the node in series between lateral ends of the auxiliary coil.

6. The active bleeder of claim 5, wherein the clamping circuit comprises:
a BJT having a first electrode coupled to the node;
a diode coupled between a control electrode of the BJT and the ground; and
a fourth resistor coupled between the control electrode of the BJT and a predetermined voltage, and
wherein, when the BJT is turned on by the bleed sense voltage, the source current flows through the BJT.

7. The active bleeder of claim 4, wherein the active bleeding controller is configured to generate the input sense voltage by flowing a mirror current to a sense resistor, the mirror current being generated by mirroring the source current.

8. The active bleeder of claim 4, wherein the active bleeding controller comprises a sample/hold unit configured to generate the sampling voltage by sampling and holding the input sense voltage with a predetermined sampling cycle.

9. The active bleeder of claim 4, wherein the active bleeding controller comprises:
a comparator configured to compare the input sense voltage and the first reference voltage with one another; and
a counter configured to count a period during which an output of the comparator has a first level.

10. The active bleeder of claim 4, wherein the active bleeding controller comprises a digital-analog converter (DAC) configured to generate the bleed reference voltage by converting a digital count signal corresponding to the count result into an analog signal, the DAC being further configured to generate a bleed reference voltage having a level based on the count signal when the count signal is higher than a predetermined reference value.

11. The active bleeder of claim 10, wherein the DAC is configured to generate a bleed reference voltage having a minimum-level when the count signal is lower than the predetermined reference value.

12. The active bleeder of claim 1, wherein the active bleeding controller comprises a comparison unit configured to generate a bleeding control signal based on a result of a comparison between the bleed reference voltage and a current sense voltage corresponding to the bleed sense voltage, wherein the bleed switch is configured to perform a switching operation based on the bleeding control signal.

13. The active bleeder of claim 12, wherein the comparison unit comprises:
a fifth resistor having a first terminal coupled with a predetermined-level voltage,
a sixth resistor having a first terminal to which the bleed sense voltage is applied and a second terminal coupled to a second terminal of the fifth resistor; and
a comparator configured to generate the bleeding control signal based on a result of comparison between the current sense voltage and the bleed reference voltage, wherein the current sense voltage is the voltage of a node at which the first and sixth resistors are coupled.

14. The active bleeder of claim 13, wherein the current sense voltage is input to a non-inverse terminal of the comparator, the bleed reference voltage is input to an inverse terminal of the comparator, and the predetermined-level voltage and values of the fifth and sixth resistors are set to values configured to prevent the current sense voltage from being a negative voltage.

15. An active bleeding method for controlling a bleed switch coupled to an input voltage that is rectified from an AC input, the active bleeding method comprising:
counting a period during which the input voltage is generated using an auxiliary voltage, the auxiliary voltage being a both-end voltage of an auxiliary coil; and
switching the bleed switch based on a result of comparison between a bleed reference voltage and a bleed sense voltage, the bleed reference voltage depending on the count result and the bleed sense voltage corresponding to a current flowing to the bleed switch,
wherein the auxiliary coil is coupled with a second coil with a predetermined turn ratio, the second coil being coupled to an output voltage of a power supply coupled to the input voltage.

16. The active bleeding method of claim 15, wherein the counting comprises supplying a source current to maintain a sense voltage with a predetermined clamping voltage, the sense voltage corresponding to the auxiliary voltage of the lateral ends of the auxiliary coil.

17. The active bleeding method of claim 15, further comprising converting the count result into the bleed reference voltage when the count result is greater than a predetermined reference value.

18. The active bleeding method of claim 15, further comprising outputting a minimum-level bleeding reference voltage when the count result is smaller than a predetermined reference value.

19. A power supply comprising:
a first coil having a first terminal coupled to an input voltage;
a power switch coupled to a second terminal of the first coil;
a second coil coupled to an output voltage;
an auxiliary coil coupled with the second coil with a predetermined turn ratio; and
an active bleeder configured to count a period during which the input voltage is generated using an auxiliary voltage generated in the auxiliary coil, the active bleeder configured to be enabled or disabled based on the count result.

20. The power supply of claim 19, wherein the active bleeder comprises:
a bleeder switch coupled to the input voltage; and
an active bleeding controller configured to generate a bleed reference voltage based on the count result and further configured to switch the bleeder switch based on a result of a comparison between the bleed reference voltage and a bleed sense voltage corresponding to a current flowing to the bleed switch.

21. The power supply of claim 20, wherein the active bleeding controller is configured to generate the bleed reference voltage by analog-converting a digital count signal corresponding to the count result when the digital count signal is higher than a predetermined reference value.

22. The power supply of claim 20, wherein the active bleeding controller is configured to generate a minimum-level bleed reference voltage when a count signal is lower than a predetermined reference value.

23. The power supply of claim 19, wherein the active bleeding controller is configured to generate an input sense voltage using a source current that is generated to maintain a sense voltage corresponding to the auxiliary voltage with a predetermined clamping voltage, the active bleeding controller being further configured to count a result of a comparison between a sampling voltage and a predetermined first reference voltage, the sampling voltage being generated based on a sampling of the input sense voltage, wherein a result of counting the comparison result of the sampling voltage and the first reference voltage corresponds to a count result of a period during which the input voltage is generated.

24. The power supply of claim 23, wherein the active bleeding controller is configured to supply the source current to a node when the sense voltage is lower than the predetermined clamping voltage, wherein a first sense resistor and a second sense resistor are coupled to the node in series between lateral ends of the auxiliary coil, the active bleeding controller being further configured to generate the input sense voltage by flowing a mirror current to a sense resistor, the mirror current being generated by mirroring the source current.

25. The power supply of claim 24, wherein the active bleeding controller is configured to generate the sampling voltage by sampling and holding the input sense voltage with a predetermined sampling cycle.
